(19) United States
(12) Patent Application Publication
(10) Pub. No.: US 2015/0074227 A1
(43) Pub. Date: Mar. 12, 2015

(54) METHOD, APPARATUS AND SYSTEM FOR A LOCATION-BASED UNIFORM RESOURCE LOCATOR

(71) Applicants: Yibei Ling, Belle Mead, NJ (US); Wai Chen, Basking Ridge, NJ (US); Onur Altintas, Kanagawa-ken (JP)

(72) Inventors: Yibei Ling, Belle Mead, NJ (US); Wai Chen, Basking Ridge, NJ (US); Onur Altintas, Kanagawa-ken (JP)

(21) Appl. No.: 14/547,491

(22) Filed: Nov. 19, 2014

Related U.S. Application Data
(63) Continuation of application No. 11/075,492, filed on Mar. 9, 2005.

(51) Int. Cl. H04L 29/08

(52) U.S. Cl. CPC H04L 67/26; H04L 67/18; H04L 67/32
USPC 709/217

(57) ABSTRACT

An aspect of the present invention is a method for routing content information to a mobile user or client application. The method preferably comprises re-directing a user request to one or more gateway servers provided via an overlay network. In another aspect, the present invention is an apparatus that includes a proxy service that intercepts content information requests to the Internet and re-directs the content requests to an overlay. Another aspect of the present invention comprises a location-based Uniform Resource Locator that includes a protocol semantic portion and a location-based resolver address portion that identifies one or more resources on a network based on the geographical location of the resources.

### CROSS-REFERENCE TO RELATED APPLICATIONS

This application is related to commonly assigned U.S. patent application Ser. No. ______ (Attorney Docket No. TELCORDIA App. No. 1538/TELCOR 1.0-012), filed on even-date herewith and entitled “Method, Apparatus and System For Location-Aware Content Push Services and Location-Based Dynamic Attachments,” the disclosure of which is hereby incorporated herein by reference.

### BACKGROUND OF THE INVENTION

The Internet is a global collection of networks that provide ubiquitous access to various types of information and allows users to communicate over expansive geographic areas, i.e., the geography of the earth. In that regard, the Internet provides a convenient means for users to access, gather and share information. Such information is typically stored on a collection of geographically scattered servers, which provide services to other machines, such as personal computers or clients and other servers, which comprise the Internet. Typically, the Internet is accessed from a web client application running on a personal computer, laptop, personal digital assistant or home appliance at a fixed location. A fixed location may comprise, for example, a user's home or office. More and more, however, there is a demand for content information residing on the Internet in mobile applications.

In particular, an emerging need of intelligent transport systems is the ability to access location-based or location-aware information in a mobile environment, such as telematic applications, roadside emergency assistance and a variety of front-seat and rear-seat applications. Telematic generally refers to onboard vehicle capability to exchange information to and from mobile platforms. Users are typically more and more demanding the capability to be able to access other transportation systems. Such transportation systems are generally considered as a mobile platform. Applications for such mobile platforms are evolving from applications in fixed location platforms. By fixed location platforms, we generally refer to a nonmobile environment, where devices typically communicate via a wired connection.

These mobile platforms typically require seamless integration of existing applications while also require addressing problems associated with mobility and heterogeneous networks. Existing applications typically include web access, reading and sending e-mails, viewing movies and listening to music. In addition, location-aware or location-based applications such as emergency notification, navigation, real-time road condition reports and location-aware advertisement insertion exists for fixed platforms and need to be supported by mobile platforms.

A typical problem associated with providing information to a mobile device is that web pages and other files are maintained by a collection of geographically scattered servers, as discussed above. Among these servers are a group of servers generally referred to as gateway servers, which are typically considered as network points that provide access or act as “gateways” between different networks. For example, an Internet Service Provider (ISP) typically provides customer access to the Internet through one or more gateway servers. Each gateway server is assigned an Internet Protocol (IP) address and each machine on the network, including servers, is also provided an IP address. Each IP address serves to uniquely identify each machine, i.e., servers. To make content searching easier and more intelligible for humans, URLs (uniform resource locators) such as www.telcordia.com, for example, are used to locate content on the web. Behind every URL, however, is an IP address or collection of IP addresses that uniquely identify one or more servers on the Internet. For example, the URL www.cnn.com is served by twelve servers. Typically, the content information is stored in a memory on the machine or may be located in a database or memory that is accessible by the machine.

In contrast to a fixed-location request for content information, when a mobile user requests information residing on the Internet, the location of the user and the location of the content information may play a role in determining how quickly the information gets routed to the user, the type of information the user may need and the costs associated with providing the requested content information to the user. For example, a user driving down a California highway may desire information specifically relating to his/her locality, e.g. the highway being traveled or a nearby town. Such information may comprise a local traffic condition, a choice of local restaurants or a local weather condition. A request for such local information by a mobile user typically results in an untimely provision of information of relatively low value to the user. That is, typically, the requested content information is retrieved from a memory or database without regard to the location of the user or the content information. This results in a delay between when the information is requested and provided. The delay may result in the information being provided to the user after the user has left the locality. Thus, the information would then be of relatively little value. In addition, the cost of providing the information to the user will typically increase in relation to an increase in the distance between the location of the user and the location of the content information.

Thus, there is a need for improving the way in which a mobile user accesses and is provided with content information residing on the Internet.

### SUMMARY OF THE INVENTION

An aspect of the present invention is a method for providing content information. The method preferably comprises receiving a request for content information from a host and routing the request for content information to a gateway server based on the geographic location of the host. The method further desirably comprises identifying a location for the requested content information based on a cost associated with a geographic location of a content server and the host and routing the identified content information to the host.

Further in accordance with this aspect of the present invention, identifying further desirably comprises accessing at least one network address associated with a plurality of Internet content servers. Further in accordance with the method, accessing desirably comprises accessing at least one Internet Protocol address associated with the plurality of Internet content servers.

The method may further desirably comprise storing a plurality of Internet addresses in the directory server. Further in accordance with this aspect of the present invention, the method may further comprise associating a geographic location with each of the plurality of Internet addresses.

Further still in accordance with this aspect of the present invention, identifying desirably comprises determining a cost associated with providing the requested content information from the content server to the host. The method may also further desirably comprise forwarding the location of the requested content information from the host to a client application.

An aspect of the present invention also comprises an apparatus for processing information requests. The apparatus preferably comprises a browser application and a memory including address and geographical location information of one or more servers connected to the apparatus. The geographical information preferably comprises global positioning information relating to the one or more servers.

The apparatus further desirably comprises a processor operable to receive a request for information from the browser application and to obtain the geographic location of a target server that includes the requested information from among the one or more servers based on the location information.

It is also desirable that the browser application comprises a Web browser.

Further in accordance with this aspect of the present invention, the global positioning information preferably includes longitudinal and latitudinal information associated with each of the one or more servers. Further still, the processor preferably obtains a geographic location of a target server by determining a cost associated with routing the requested information of the target server to the apparatus.

Further in accordance with this aspect of the present invention, the processor preferably obtains geographic location of the target server by determining a loading factor associated with obtaining the content information from the target server. Preferably, the apparatus is selected from the group consistent of a personal digital assistant, a cell phone, a portable computer, a digital wallet and an electronic wallet.

An aspect of the present invention is an automobile comprising a browser application, a memory and a processor. The memory preferably includes address information and location information associated with a plurality of gateway servers that are coupled to the automobile through a communication network that includes a wireless link to the automobile. The processor is preferably operable to receive a request for content information from the browser application and to process the request for content information based on the address and location information associated with the gateway servers and the location information of the automobile.

In accordance with this aspect of the present invention, the processor preferably processes the request for content information by determining the address of a target gateway server located closest to the automobile from among the plurality of gateway servers.

Further in accordance with this aspect of the present invention, the processor further processes the request for content information by translating the request for content information into a uniform resource locator associated with the target server. In addition, the uniform resource locator comprises the Internet protocol address of the target server and the target server comprises a machine on an overlay service network. Most preferably, the overlay service network is provided in parallel and coupled to the Internet.

Further in accordance with the aspect of the present invention, the processor further processes the request for content information by sending the request to the target server. Most preferably, the processor communicates with the target server using a protocol selected from the group consisting of the hypertext transfer protocol, session initiation protocol and simple object access protocol.

Further still, the automobile preferably includes an antenna that provides a link to a global positioning system. Further in that regard, the global positioning system preferably tracks the location of the automobile and provides tracking information to the automobile, such tracking information comprising the location information of the automobile. Most preferably, the location information comprises longitudinal and latitudinal information associated with the automobile.

Further in accordance with this aspect of the present invention, the target server operates to locate a content server for providing the requested content information by determining a routing cost associated with providing the content information from the content server to the automobile. Preferably, the target server determines the routing cost based on the geographic location of the consent server and the tracking information of the automobile. The routing cost may also be determined based on a loading capability associated with the target server, the time of the date or the type of content information that is requested.

In another aspect, the present invention is a system comprising a mobile unit connected to a communication network and one or more gateway processors connected to the mobile unit through the communication network. In accordance with this aspect of the present invention, the system further desirably comprises a content directory processor connected to at least one or more gateway processors. The content directory processor is preferably operable to determine the location of content information requested by the mobile unit. Most preferably, that determination is based on geographic location information associated with the mobile unit and the geographic location information associated with the content information. The communication network preferably comprises the Internet and the mobile unit is connected to the Internet through a radio frequency channel.

Further in accordance with this aspect of the present invention, the mobile unit desirably includes an application that determines which of the gateway processors the mobile unit should send a request for content information to based on the geographic location of the mobile unit.

The system may further desirably include a content source that includes the content information requested by the mobile unit.

Further in accordance with this aspect of the present invention, the determination comprises locating a source for the content information closest to the mobile unit.

In another aspect, the present invention may comprise a uniform resource locator. The uniform resource locator preferably comprises a protocol semantic portion and a location-based resolver address portion. Most preferably, the location-based resolver address portion identifies one or more resources on a network based on the geographical location of the resources.

Further in accordance with this aspect of the present invention, the one or more resources preferably comprise one or more servers on the network. Most preferably, the network comprises a plurality of server overlaid on the Internet.

Further in accordance with this aspect of the present invention, the protocol semantic portion of the uniform resource locator desirably comprises a protocol selected from the group consisting of Hypertext Transfer Protocol (HTTP), Simple Object Access Protocol (SOAP) and the Session Initiation Protocol (SIP).

Most preferably, the location-based resolver address portion desirably comprises an association between an Internet Protocol (IP) address and longitudinal and latitudinal location information associated with one of the one or more resources.

### BRIEF DESCRIPTION OF THE DRAWINGS

FIG. 1 depicts a system in accordance with an aspect of the present invention.

FIG. 2 illustratively depicts an apparatus in accordance with an aspect of the present invention.

FIG. 3 illustratively depicts a functional diagram of a system in accordance with an aspect of the present invention.

FIG. 4 illustratively depicts a uniform resource locator in accordance with an aspect of the present invention.

FIG. 5 illustratively depicts a functional diagram of a system in accordance with an aspect of the present invention.

FIG. 6 illustratively depicts a process flow in accordance with an aspect of the present invention.

FIG. 7 illustratively depicts a process flow in accordance with an aspect of the present invention.

### DETAILED DESCRIPTION

Additional details associated with various aspects of the present application are described in commonly assigned U.S. patent application Ser. No. ______ filed on even-date herewith, (Attorney Docket No. TELCORDIA App. No. 1538/TELCOR 1.0-012) and entitled “Method, Apparatus and System For Location-Aware Content Push Services and Location-Based Dynamic Attachment,” the disclosure of which is hereby incorporated herein by reference.

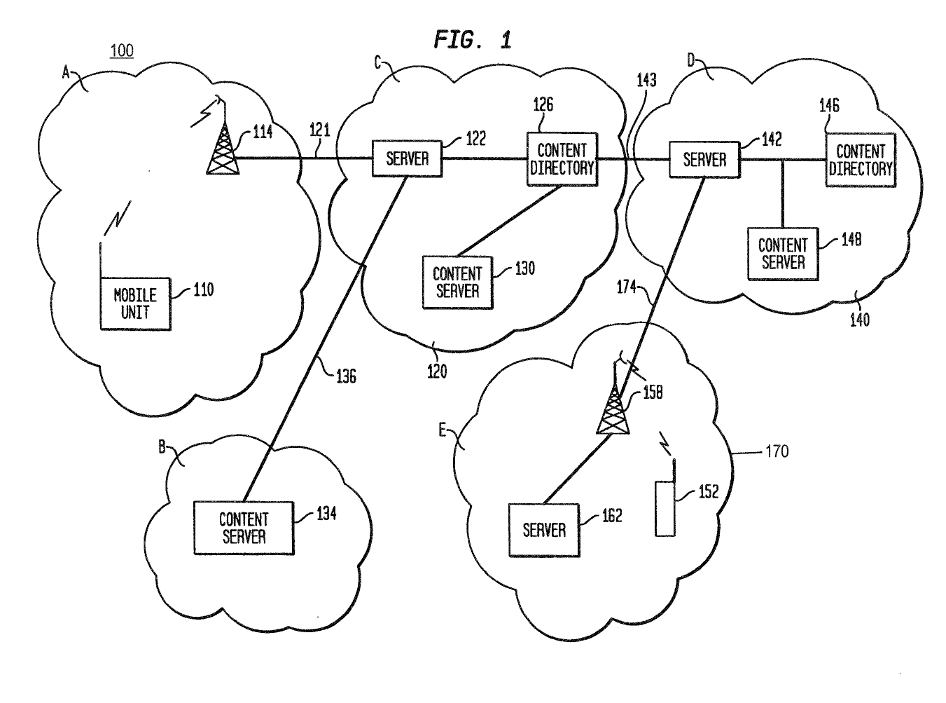

FIG. 1 illustratively depicts a system in accordance with an aspect of the present invention. The system 100 includes a mobile unit 110 in a geographic area A. The mobile unit 110 is shown as communicating wirelessly through a radio frequency tower 114 to a network 120. The network 120 and radio frequency tower 114 are connected via link or line 121. The network 120 includes a server 122, a content directory server 126 and a content server 130. The network 120 may also include other servers, routers and other equipment necessary to communicate data or information between the mobile unit 110, server 122, and content directory server 126 and content server 130. In addition, the other equipment that comprise the network 120 and the other networks shown in FIG. 1 and discussed hereinbelow may also include routers, switches, multiplexers and other equipment necessary to communicate information among the servers, mobile units, client applications, etc., that may exchange information using the network. As shown, the server 122 is also connected to a content source 134 via a link or line 136. Preferably, the content source 134 is located in a geographic area B that is located relatively close to geographic area A. Most preferably, the content source 134 is located in the same geographic area as the mobile unit, although co-location of the content source 134 and the mobile unit 110 is not necessary to realize the advantages associated with the various aspects of the present invention. The network 120 is located in geographic area C.

The network 120 is shown as also connected to another network 140 via a line or link 143. The network 140 includes a server 142, a content directory 146 and a content server 148. Similar to network 120, the network 140 includes a plurality of routers, switches and other equipment used to communicate data or information between the networks and to network subscribers. These network subscribers may be connected to the network via a whole unit, such as 110. The network 140 is remotely located from the network 120 and will typically be in a different geographic area D.

The system may further include another mobile unit 152 communicating through a radio frequency tower 158. In addition, a server 162 is connected to the tower 158. The mobile unit 152, tower 158 and server 162 comprise a network 170. The network 170 is located in geographic area E, which is remote to areas C and D. The network 170 is connected to network 140 via line or link 174.

Each of the lines or links 121, 136, 143 and 174 may comprise media, e.g., copper, coaxial or fiber cable, etc., and associated electronics and equipment for communicating information between the networks. The electronic equipment may comprise circuit or packet switches, routers, repeaters, digital data terminals and associated software that condition and communicate the information between desired destination points. The aforementioned details of the media and associated electronics are generally known to one of ordinary skill and ancillary to the present invention, and, therefore, are discussed in detail where appropriate.

In accordance with an aspect of the present invention, as the mobile unit 110 moves about in geographic area A, requests for content information are initiated from the mobile unit 110. Such requests may include, for example, downloading music or movies, requesting traffic conditions or requests for emergency notification. Additional requests may include navigation or direction information and location-aware advertisements. The information requested by the mobile unit 110 is located on one or more content servers. In accordance with this aspect of the present invention, it may prove more efficient if the user receives the requested information from a content server located relatively nearby the mobile unit 110.

The geographic area A may comprise a state in the U.S., any country, such as Germany or Japan for example, a city or town, a shopping mall, or a building. Additional details regarding the organization, segmenting or selection of geographic areas, such as A, in accordance with the various aspects of the present, may be obtained in the previously referenced commonly assigned U.S. application Ser. No. ______ (Attorney Docket No. TELCORDIA App. No. 1538/TELCOR 1.0-012).

In addition, in some circumstances, the information requested is location-based or location-aware information. For example, if a user requests a list of restaurants in geographic area A, such information may be located in a server in geographic area A. In addition, if the user requests information such as the local weather conditions, such information may be located in a server specifically associated with area A. Moreover, the location of the mobile user 110 and the content server may affect the costs associated with providing the requested information to the user. In that regard, if the user requests a movie, the user may be able to avoid roaming charges and the like if the information is retrieved from a content server within the same geographic area/location as the mobile unit 110.

In accordance with this aspect of the present invention, the user's request for content information is communicated via a location-based virtual uniform resource locator. The location-based uniform resource locator provides a mechanism for addressing resources in a communication network, such as the Internet, maintained by a collection of geographically scattered servers (gateway servers). The location-based uniform resource locator preferably points to the locations of a pool of Internet resources instead of the location of one Internet resource. For example, and as discussed in greater detail below, when the mobile unit 110 issues a request using a location-based uniform resource locator, the request is transparently re-directed to one of a plurality of service or gateway servers, such as server 122, based on the present location of the mobile unit 110. Upon receipt of the request, the server 122 initiates a request to a content directory server 126, which identifies the location of the requested content information. In accordance with an aspect of the present invention, if the requested content information is cached in one of the gateway servers that form the overlay network, then the content information is routed from the caching gateway server to the gateway server that initiate the request, e.g., server 122. The initiating gateway server then routes the requested content information to the mobile unit 110. Where the requested content information was already cached in the gateway server nearest the mobile unit (e.g., server 122), then that gateway server would then be able to directly provide the information to the mobile unit.

Where none of the gateway servers that comprise the overlay service network have the requested information, then the content directory server 126 accesses the Internet or another network to locate the content information. The information may be located on a content server, such as content server 134, on a third party network. Once the content information is located it is then routed to the gateway server nearest the mobile (and which requested the content information on behalf of the mobile), where it cached by this gateway server. In the event that the same content information is requested by another mobile unit or another gateway server in the overlay network, it may then be routed from the gateway server it is currently cached in as described above. By caching the content information in the overlay network latency in servicing requests by mobile units may be reduced. The content information may remain cached for a predetermined amount of time or based on the load of the caching server.

In identifying the location of the requested content information, the directory server 126 may use a minimum content routing cost to determine which gateway or content server should be used to provide the information. The content directory server 126 then returns a location-based uniform resource locator associated with the content server to the service server 122, which then returns the appropriate uniform resource locator to the mobile unit 110 and facilitates delivery of the content information to the mobile unit 110. The mobile unit 110 then uses the returned uniform resource locator to access the content information. The returned uniform resource locator is also location-based and may point to a content server nearby the geographic area A, such as content server 134 in geographic area C. Preferably, server 122 transparently routes the content information to the mobile unit 110 based on the returned uniform resource locator.

Service server 122 or, in general, a gateway server preferably acts as a cache server of content sources, as well as a gateway to mobile terminals. The caching capability of the gateway servers allow content information from content servers, such as a server associated with http://www.cnn.com, to reduce the latency associated with content retrieval. As discussed in further detail below, mobile terminals communicate with gateway or service servers in an overlay network. The appropriate gateway server is identified using a location-based resource locator as discussed below. As previously discussed, if the content requested by a mobile terminal is cached in the overlay service network, the connecting gateway server is able to identify a gateway server in the overlay service network, retrieve the content from that gateway server and then forward the content to the mobile terminal. If the requested content is not cached in the overlay service network, then the gateway server sends a request to a content source server in, for example, a third party network. The information is then routed from the content source to the mobile terminal.

In accordance with another aspect of the present invention, the service server 122 and content directory server 126 are preferably implemented as an overly network on the current Internet. In this way, the service server 122 receives requests based on the location-based uniform resource locators and directs those requests to an appropriate content directory server, such as server 126, for further processing. The content directory server 126 preferably includes a pool of Internet resources and addresses and determines the Internet address that the mobile unit should use to access the requested content information. That determination may be based on the present geographical location of the mobile unit or the geographical location of the service server. In addition, that determination may include consideration of a minimum content routing cost for providing the information between the content server and the mobile unit. The minimum content routing cost may include consideration of such factors as roaming charges, the loading capacity of one content server versus another content server or whether the mobile unit is registered with a provider of the content information.

As a further illustrative example, let's assume that the mobile unit 110 comprises an automobile that includes onboard Web browsing capability, a link to a wireless network such as the network illustrating depicted by tower 114 and a navigation system that allows the automobile to determine and track its location. The navigation system may comprise a link to an antenna that includes a link to a GPS satellite system that provides longitude and latitude information for the automobile's location. The wireless network may comprise a cellular network based on a Code Division Multiple Access (CDMA), Time Division Multiple Access (TDMA) or Groupe Speciale Mobile (GSM) systems or network. Other networks may include WLAN or the like.

As the automobile travels within geographic area A, a request is issued for a movie, which may be delivered as a downloadable video stream to the automobile, using the onboard Web browsing capability. The movie request is then communicated to gateway server 122, using the tower 114. The gateway server 122 is located in area C and associated with a content directory server 126 to which it forwards the request. Assuming that the requested content information is not cached in the overlay service network, the content directory server 126 processes the request by determining the lowest cost at which the requested movie may be provided to the automobile.

If the content server 126 makes the cost determination based on the location, of the automobile and content server, then, assuming that content server 134 is the closest content source to the mobile unit 110, the movie will then be provided from content server 134 through the server 122. If, on the other hand, the content directory server 126 determines that the movie may be obtained at minimum cost from a home network associated with the automobile, e.g., network 140, because the roaming charges associated with content server 134 outweigh savings achieved by location, then the content directory server 126 directs server 122 to provide the movie from content server 148. In this way, the content directory server 126 may determine the minimum cost content provider based on the foregoing metrics, e.g., location or roaming charges, or other metrics including time, or type of content. In any case, the automobile may then be provided with the movie at the lowest available cost in accordance with this aspect of the present invention.

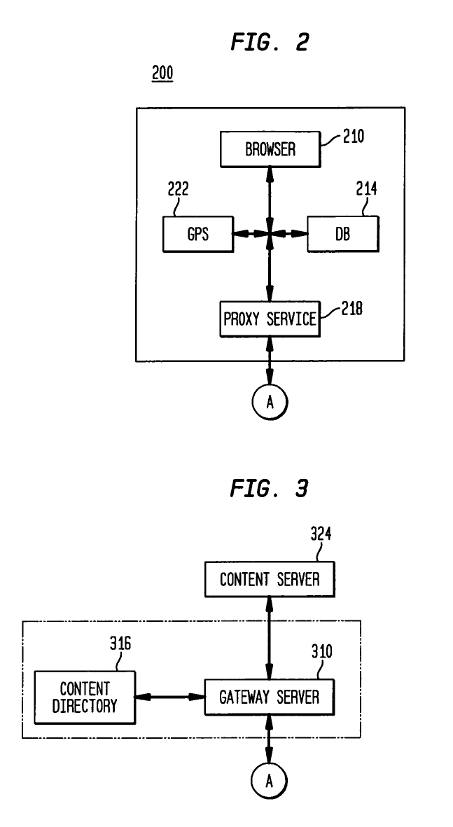

FIG. 2 illustratively depicts a functional block diagram of a mobile unit 200 in accordance with an aspect of the present invention. The mobile unit 200 preferably includes a browser 210, a database 214, a proxy service 218 and a GPS block 222. The browser 210 may comprise any known web browser application including Explorer, Firefox, Netscape or Avant. The browser 210, in general, is an application program that allows a user to look at and interact with information on the World Wide Web or Internet. The browser 210 therefore provides an interface to the user so that the user may request content information that may be located on the Internet. The browser 210 also includes an interface to the proxy service 218.

The proxy service 218 is also connected to database 214. The proxy service 218 functions as a location resolver, i.e., translating the present geographic location to an IP address of a nearby gateway server. In particular, the database uses information in GPS block 222 to perform a function similar to that performed by a domain name server. As is generally known in the art, domain name servers comprise databases that map uniform resource locator (URLs) to Internet Protocol (IP) addresses. In that regard, the database 214 acts as a local database for storing geographic information and IP addresses of gateway servers. The gateway servers preferably comprise servers, e.g., processors and associated memory with links to the network, on an overlay service network. The proxy service 218 acts as a browser interface that intercepts requests from the web browser and transparently re-directs those requests to a gateway server, illustratively depicted as A in FIG. 2. More particularly, the GPS block 222 obtains real-time geographic location or position information associated with the mobile device and provides that information to the proxy service 218. The proxy service 218 uses the geographic location or position information in accessing the local database 214 to determine the approximate gateway server to which the information should be directed.

As shown in FIG. 3, the gateway server 310 receives a message from the proxy service 218. The gateway server 310 then contacts a content directory 316 to identify the location of the content information requested by the proxy service 218. The location of the information requested is determined based on a minimum content routing cost as, for example, discussed above. The content directory 316 may comprise a server or a memory and associated processor that uses location information associated with the mobile unit to determine the appropriate location from which to access the requested information. Once a content server 324 is located, the gateway server 310 then routes the content information to the mobile unit so that the mobile unit can receive or access the requested information. A content directory server may comprise one or more look-up tables that allow for an association between content information and location and the other routing metrics discussed herein. A content directory server may also desirably include one or more software applications that use the information in the look-up tables to determine a routing cost associated with a request.

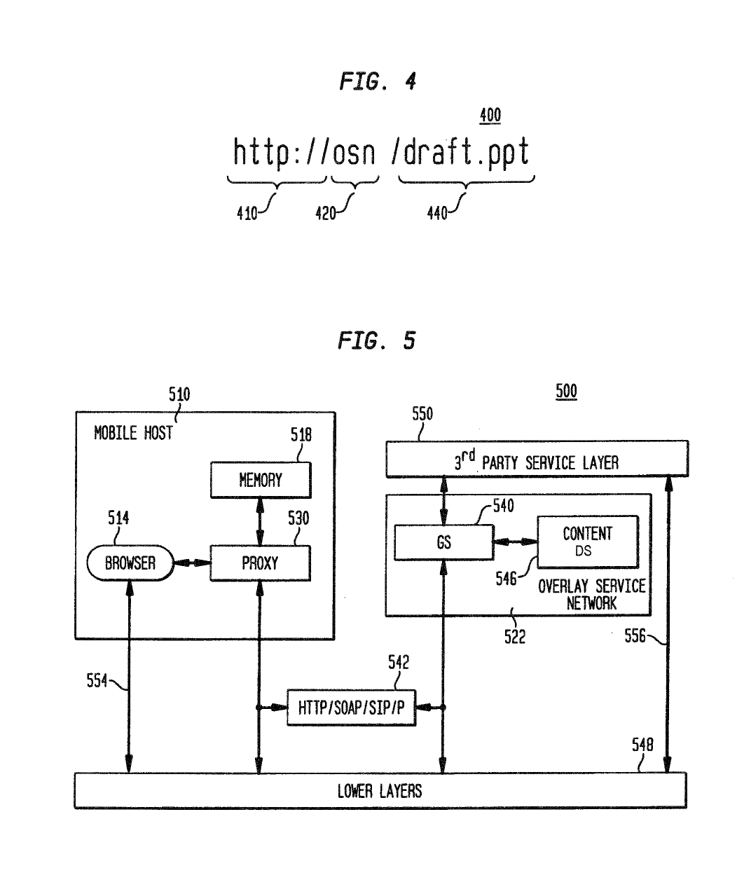

Turning now to FIG. 4, there is illustrated a location-based uniform resource locator 400 in accordance with an aspect of the present invention. Functionally, a location-based uniform resource locator 400 is a generalized version of a traditional URL. However, instead of pointing directly to the location of an Internet resource, a location-based uniform resource locator 400 points to the location of a pool of Internet resources maintained by a plurality of geographically scattered servers, such as gateway server 310 or server 122. In that regard, the location-based uniform resource locator 400 functions similarly to the Domain Name System in that it resolves IP addresses of servers. However, unlike the Domain Name System, a location-based uniform resource locator 400 uses the location information, e.g., latitude, longitude, elevation, to resolve the IP address of a server which is geographically close to a mobile unit from which a request for content information is issued. Thus, unlike a DNS-based scheme, the location-based uniform resource locator preferably resolves IP addresses based on geographical location information, rather than using Domain Names.

As shown in FIG. 4, the location-based resource locator may employ the same semantic as a traditional URL. In that regard, the location-based URL includes a protocol 410, a location-based resolver address 420 and a file name 440. The location-based resolver address 420 preferably corresponds to an IP address of a gateway server. The gateway servers comprise a network of servers that are overlayed on a network (e.g., an overlay service network), such as the Internet. Within the overlay service network (OSN) IP addresses are associated with each gateway server. The overlay service network represents a geographic area covering a collection of gateway servers, wherein the geographic deployment of the gateway servers will typically be determined by business needs, customer demand and the capability associated with each gateway server. Each gateway server within the overlay service network has autonomy in managing and hosting/caching localized content information such as local traffic information, local hotels and local restaurants, but also has a great deal of flexibility and adaptability in sharing information with other gateway servers. It is expected that the deployment of the gateway servers will be relatively stable and changes to deployment will be relatively infrequent, thus reducing overhead related to updating local databases, such a database 214. However, a change in the deployment of gateway servers may be updated in the local database by a push-based or pull-based process as is discussed in greater detail in U.S. application Ser. No. ______ (Attorney Docket No. TELCOR App. No. 1538/TELCOR 1.0-012).

In particular, the complexity of managing dynamically changing geographic distribution of gateway servers as well as user mobility may be controlled by assigning each user a primary gateway server based on a residency area in accordance with an aspect of the present invention. The primary gateway server stores the user's profile (i.e., preferences) and also stores up-to-date geographic distribution data for the gateway servers that comprise the overlay service network. When a user moves out of the assigned primary residency area, the location of the user will be sent back to the primary gateway server, which returns an IP address of a gateway server responsible for the area in which the user is currently located. The assignment of a gateway server other than the primary gateway server for managing requests or transactions associated with a particular mobile unit may be done transparently such that the user is not aware that the role of the primary gateway server has been handed off to another gateway server in the overlay service network. As a result, a change in the geographic distribution of the gateway servers can be made from a single location and may be automatically configured by the mobile unit or device when needed.

The location-based uniform resource locator in accordance with various aspects of the present invention takes advantage of the benefits of the geographically distributed servers, which include: the ability to stand up to unpredictable traffic and load requirements; and the hosting of geo-specific information by a server that is likely to be near the geo-specific location associated with a request (e.g., local traffic information, local hotels and restaurant information).

In accordance with an aspect of the present invention, the general architecture provides a way for a mobile device to send a request to a gateway server that is geographically close to the current location of the mobile device. This may be accomplished by using current location information provided by the GPS block 222 provided in a mobile device. For example, Table 1 represents a portion of a local database, e.g., database 214, according to an aspect of the present invention, wherein the values in the longitude 1 and latitude 1 columns may represent the uppermost left point of a rectangular area, the values in the longitude 2 and latitude columns represent the lower-right most point of the rectangular area, and the values in the IP address column provide a network address of a gateway server residing in the corresponding rectangular area.

TABLE 1

| Longitude1 | Latitude1 | Longitude2 | Latitude2 | IP |
|---|---|---|---|---|
| −74.47 | 40.47 | −78.57 | 40.57 | 205.132.610 |
| −78.57 | 40.57 | −79.99 | 50.67 | 199.23.23.123 |

Using Table 1, if the mobile device is in the location defined by the upper-left most point (−74.47, 40.47) and the lower-right most point (−78.57, 40.57), then the gateway server with IP address 205.132.6.10 is selected. Accordingly, if the user sends a request such as HTTP://OSN/draft.PPT, the proxy service intercepts this request and modifies the request letter to HTTP://205.132.6.10/scripts/dispatcher.DLL?HTTP=HTTP://osn/www.cnn.com/draft.PPT, such that the IP address 205.132.6.10 has been dynamically determined by the current location of the mobile unit. This step of IP location resolution and re-direction is preferably performed transparently to the user. Upon receipt of the request, the gateway server, e.g., server 310, contacts a contact directory server, e.g., server 316, to identify the location of the requested content information based on, for example, a minimum routing cost. The requested content source is then routed to the mobile device via the gateway server.

FIG. 5 illustratively depicts a functional diagram in accordance with an aspect of the present invention. The system 500 includes a mobile host 510, which includes a browser application 514, and a memory 518 housing location information and address information associated with the mobile host 510 and an overlay service network 522. The mobile host 510 further includes a proxy application, i.e., block 530, that communicates with the browser 514 and memory 518. The mobile host 510 communicates through the proxy 530 to the overlay services network 522 using any number of known protocols. These protocols may include hypertext transfer protocol (HTTP), Simple Object Access Protocol (SOAP) or the Session Initiation Protocol (SIP).

The HTTP Protocol is a set of rules for transferring files (text, graphic images, sound, video, and other multi-media files) on the World Wide Web. Where the HTTP protocol is used, the browser application 514 comprises a client that sends requests to server machines through the proxy 530 as described above. The server machines each include a HTTP application that receives the request and sends back the requested file or files associated with the request. SOAP provides a way for a program running in one type of operating system to communicate with a program in the same or another type of operating system by using the HTTP Protocol and its Extensible Markup Language (XML) as the mechanism for information exchange. SIP is a protocol for initiating an interactive user session that involves multimedia elements such as video, voice, chat, gaming and virtual reality. The operational details of the foregoing protocols are known to those skilled in the art and is beyond the scope of this disclosure.

As is shown in FIG. 5, the proxy application 530 communicates with one or more gateway servers 540 using the protocol 542 and the lower layers 548 of a network. The lower layers preferably comprise layers 1 through 5 of the Open Systems Interconnection (OSI) reference model. In accordance with the OSI reference model, layer 1 is the physical layer, layer 2 is the data link layer, layer 3 is the network layer, layer 4 is the transport layer, layer 5 is the session layer, layer 6 is the presentation layer and layer 7 is the application layer. The HTTP, SOAP and SIP protocols are generally considered to operate at layer 6. The application layer generally comprises e-mail or other web applications including file transfers or directory services. Messages generated by the proxy application 530 are received at gateway server 540 and further processed by a content directory server, based on, for example, a minimum routing cost. The gateway server 540 then accesses a third party service layer, i.e., block 550, to retrieve the information requested by the mobile host 510 and thereafter routes the requested information to the mobile host 510.

FIG. 5 also illustrates that the mobile host 510 may communicate directly to the third party service layer 550 using link 554 and 556. If the mobile host 510, however, uses links 554, 556 to access or obtain requested content information from third party service layer 550 requested information would not be routed without using the overlay service network 522. Therefore, such information may not be provided using the minimum routed costs.

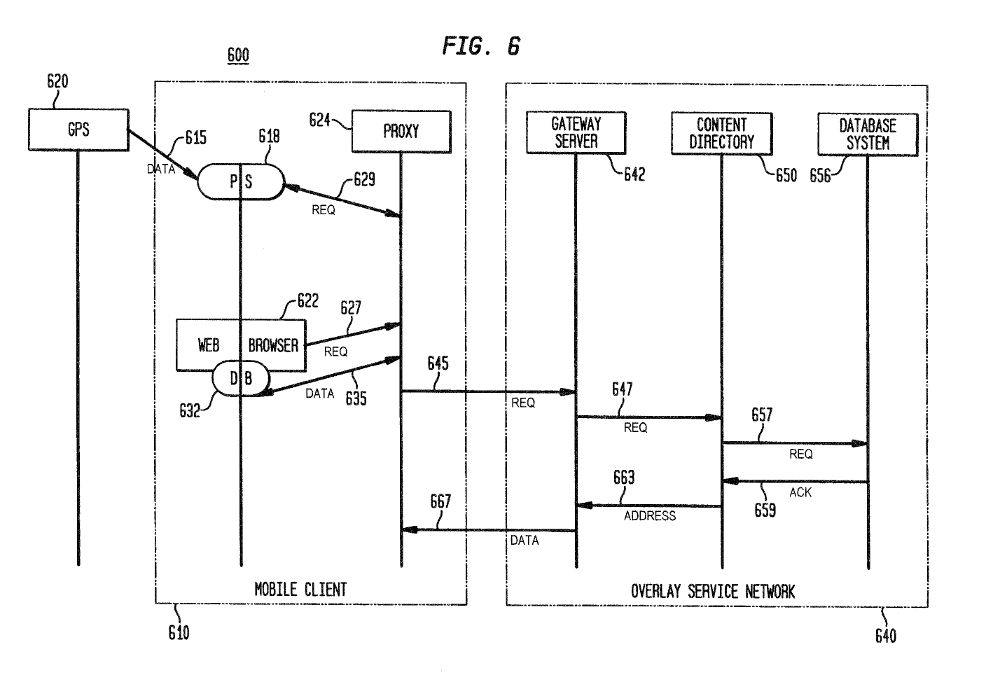

FIG. 6 illustratively depicts a method 600 in accordance with an aspect of the present invention. As shown in FIG. 6, the mobile client 610 receives (line 615) location data from a global positioning system 620. That data comprises latitudinal and longitudinal data associated with the geographic location of the mobile client 610. When a request for content information is initiated by the web browser 620, the proxy application 624 intercepts the request (line 629). The proxy application 624 uses the GPS information 618 and information from database 632 to determine the appropriate gateway server which should process the request in the overlay service network 640.

As shown in FIG. 6, the proxy application 624 will typically direct the request to one gateway server 642 (line 645). The gateway server then accesses (line 647) a content directory server 650. The content directory server 650 processes the request by determining the appropriate database system that should be contacted to deliver the content information. As shown in FIG. 6, the content directory server 650 contacts a database system 656 using line 657. The database system 656 then acknowledges receipt of the request and confirms the availability of the information (line 659). The content directory 650 receives the acknowledgement and confirmation and forwards the address of the database system to the gateway server 642, as is illustrated by line 663. The gateway server 642 thereafter establishes the appropriate links and connections necessary for the requested content information to be delivered from the database system 656 to the mobile client 610, as is illustrated by line 667.

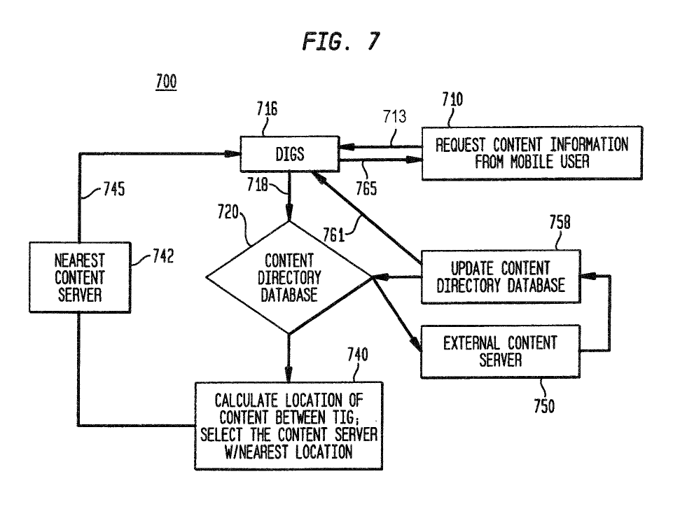

Turning now to FIG. 7, there is shown a process flow diagram 700 in accordance with an additional aspect of the present invention. The process begins with a request for content information from a mobile user, block 710. The request is forwarded (line 713) to an information gateway, 716. The information gateway server 716 forwards the request (line 719) to a content directory database 720. If the content directory database 720 finds an entry in its database for the requested information, it then calculates the location of the content information based on, for example, the location of the information gateway server and the content server, block 740. Most preferably, a content source nearest the information gateway server is selected and the location is returned to the information gateway server, as is shown by block 742 and line 745. The content source may comprise an information gateway server in the overlay service network or

If the content directory server 720 cannot find a content server in its database, it then accesses an external content server 750 that has the requested content information. The content directory database is then updated to include the new external content server address, block 758, and the address information associated with the external content server is then provided to the information gateway server 716 via line 761. When the information gateway server 716 receives the address or location of the content server, it then facilitates delivery of the requested content information to the mobile user as indicated via line 765. In addition, the information gateway server 716 stores the content information in a cache memory, which may then be used to respond to subsequent requests for that content information.

As discussed above, an aspect of the present invention includes a method of determining the minimum content routing cost associated with delivering the requested content information to a mobile user. In particular, the content routing determination may use a variety of data to determine the minimum content routing cost, for example, position information and system load information. For example, the minimum content routing cost may account for the following factors: geo-distance between current location of the mobile device and the information gateway server; network distance (number of hops) between the current location of the mobile device and the information gateway server; run-time system mode of the information gateway server; and the network usage environment (available bandwidth) for the information gateway server. Any combination of these factors may be considered and given different weights by the system in calculating routing costs.

The various aspects of the present invention may be utilized advantageously by any carrier and existing network structure. In addition, each information gateway server may be autonomous, running independently in managing a localized information. Furthermore, information may be exchanged efficiently among the information gateway servers via the overlay service network. The system load may also be shared across multiple gateway servers resulting in improvement in reliability and resilience to various types of transient failures.

The various aspects of the present invention also advantageously allow for the support of a number of emerging applications, including location-aware notification, location-aware advertising insertion, location-aware emergency event notification, and real-time traffic reporting. In particular, the location-based URL of the present invention supports location-aware content push service comprising the automatic delivery of various types of messages, e.g., media streaming (audio, video) and plain text, to users in a specified geographic area in a real-time fashion. The geographic area may be dynamically defined to cover a township, a city, a state, or even a country. Examples of applications that may benefit from such treatment include real-time location-aware road condition notification, real-time location-aware advertisement insertion and real-time location emergency notification. Specific information that may be transmitted to the user includes advertising, news bulletins, weather forecast, stock quotes, etc. Further, the information can be very specific to the user, such as the latest news from a favorite TV show or a work-related notice.

Various aspects of the present invention may be implemented using software stored in memory or on media, e.g., CD-ROMs, and that provide instructions executable by a microprocessor or microcomputer. Such aspects of the present invention may also be implemented using any other lower level code that operates using integrated circuits (e.g., ASICs) or digital signal processors. In addition, the mobile units may comprise a cellular telephone, a personal digital assistance, a laptop or a vehicle equipped with a memory for storing the instructions associated with the software and a processor for executing the software as well as an antenna for receiving GPS information. The one or more gateway servers may be implemented on any commercially available server platform including Microsoft, Novell or Hewlett Packard platforms. In addition, the one or more gateway servers are preferably provided as an overlay network on the Internet or other communication network and allow for messages destined for the Internet to be intercepted and re-routed so that the user may take advantage of the various aspects of the present invention including, for example, a routing cost.

Although the invention herein has been described with reference to particular embodiments, it is to be understood that, these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1-20. (canceled)

21. An apparatus for providing content information to a mobile unit, the apparatus comprising:
a plurality of gateway servers forming an Overlay Service Network (OSN) overlaying a geographic portion of a larger network; and
a communication protocol for routing from the mobile unit to one of the gateway servers in the OSN, a request for the content information, the request being redirected to the gateway server in the OSN based on a geographic location of the mobile unit and a location-based Uniform Resource Locator (URL) that includes a location-based resolver address portion that identifies the gateway server in the OSN based on a geographical location of the gateway server in the OSN;
wherein the gateway server in the OSN identifies a location for the requested content information based on a cost associated with the geographic location of a content source and the mobile unit, and obtains and routes the requested content information to the mobile unit.

22. The apparatus as recited in claim 21, wherein the larger network is the Internet.

23. The apparatus as recited in claim 22, wherein the location-based resolver address portion comprises an association between an Internet Protocol (IP) address and longitudinal and latitudinal location information associated with the gateway server in the OSN.

24. The apparatus as recited in claim 21, wherein when the requested content information is located in another one of the plurality of gateway servers in the OSN, the gateway server in the OSN obtains the requested content information from the other gateway server in the OSN, caches the requested content information in local memory, and routes the requested content information to the mobile unit.

25. The apparatus as recited in claim 21, wherein when the requested content information is not located in any of the gateway servers in the OSN, the gateway server in the OSN obtains the requested content information from a server external to the OSN, caches the requested content information in local memory, and routes the requested content information to the mobile unit.

26. The apparatus as recited in claim 21, wherein the gateway server in the OSN is assigned as a primary gateway server for the mobile unit based on the geographic location of the gateway server in the OSN and a primary residency area of the mobile unit;
wherein the primary gateway server stores a user profile for the mobile unit and stores current geographic location information for the plurality of gateway servers in the OSN.

27. The apparatus as recited in claim 26, wherein when the mobile unit moves out of the primary residency area, the primary gateway server receives a new location area of the mobile unit and sends to the mobile unit, an address of another gateway server in the OSN responsible for the new location area of the mobile unit.

28. A method in an Overlay Service Network (OSN) for providing content information to a mobile unit, wherein the OSN includes a plurality of inter-connected gateway servers overlaying a geographic portion of a larger network, the method comprising the steps of:
routing from the mobile unit to one of the gateway servers in the OSN, a request for the content information, the request being redirected to the gateway server in the OSN based on a geographic location of the mobile unit and a location-based Uniform Resource Locator (URL) that includes a location-based resolver address portion that identifies the gateway server in the OSN based on a geographical location of the gateway server in the OSN;
identifying by the gateway server in the OSN, a location for the requested content information based on a cost associated with the geographic location of a content source and the mobile unit; and
obtaining and routing the requested content information to the mobile unit.

29. The method as recited in claim 28, wherein the larger network is the Internet.

30. The method as recited in claim 29, wherein the location-based resolver address portion comprises an association between an Internet Protocol (IP) address and longitudinal and latitudinal location information associated with the gateway server in the OSN.

31. The method as recited in claim 28, further comprising, when the requested content information is located in another one of the plurality of gateway servers in the OSN, the gateway server in the OSN obtaining the requested content information from the other gateway server in the OSN, caching the requested content information in local memory, and routing the requested content information to the mobile unit.

32. The method as recited in claim 28, further comprising, when the requested content information is not located in any of the gateway servers in the OSN, the gateway server in the OSN obtaining the requested content information from a server external to the OSN, caching the requested content information in local memory, and routing the requested content information to the mobile unit.

33. The method as recited in claim 28, further comprising:
assigning the gateway server in the OSN as a primary gateway server for the mobile unit based on the geographic location of the gateway server in the OSN and a primary residency area of the mobile unit; and
storing by the primary gateway server:
a user profile for the mobile unit; and
current geographic location information for the plurality of gateway servers in the OSN.

34. The method as recited in claim 33, further comprising, when the mobile unit moves out of the primary residency area:
receiving by the primary gateway server, a new location area of the mobile unit; and
sending from the primary gateway server to the mobile unit, an address of another gateway server in the OSN responsible for the new location area of the mobile unit.

35. A system for providing content information to a mobile unit, the system comprising:
a plurality of gateway servers forming an Overlay Service Network (OSN) overlaying a geographic portion of a larger network; and
a mobile unit that utilizes a location-based Uniform Resource Locator (URL) to send a request for the content information to one of the gateway servers in the OSN, the request being redirected to the gateway server in the OSN based on a geographic location of the mobile unit and a geographical location of the gateway server in the OSN, wherein the location-based URL includes a location-based resolver address portion of the that identifies the gateway server in the OSN;
wherein the gateway server in the OSN identifies a location for the requested content information based on a cost associated with the geographic location of a content source and the mobile unit, and obtains and routes the requested content information to the mobile unit.

36. The system as recited in claim 35, wherein the larger network is the Internet.

37. The system as recited in claim 35, wherein when the requested content information is located in another one of the plurality of gateway servers in the OSN, the gateway server in the OSN obtains the requested content information from the other gateway server in the OSN, caches the requested content information in local memory, and routes the requested content information to the mobile unit.

38. The system as recited in claim 35, wherein when the requested content information is not located in any of the gateway servers in the OSN, the gateway server in the OSN obtains the requested content information from a server external to the OSN, caches the requested content information in local memory, and routes the requested content information to the mobile unit.

39. The system as recited in claim 35, wherein the gateway server in the OSN is assigned as a primary gateway server for the mobile unit based on the geographic location of the gateway server in the OSN and a primary residency area of the mobile unit;
wherein the primary gateway server stores a user profile for the mobile unit and stores current geographic location information for the plurality of gateway servers in the OSN.

40. The system as recited in claim 39, wherein when the mobile unit moves out of the primary residency area, the primary gateway server receives a new location area of the mobile unit and sends to the mobile unit, an address of another gateway server in the OSN responsible for the new location area of the mobile unit.
